(19) United States
(12) Patent Application Publication
(10) Pub. No.: US 2019/0089224 A1
(43) Pub. Date: Mar. 21, 2019

(54) ACTUATOR

(71) Applicant: Nidec Corporation, Kyoto (JP)

(72) Inventors: Katsunobu HATANI, Kyoto (JP); Masaaki NAKAGAWA, Kyoto (JP); Tomoyoshi YOKOGAWA, Kyoto (JP)

(21) Appl. No.: 16/122,920

(22) Filed: Sep. 6, 2018

Related U.S. Application Data
(60) Provisional application No. 62/559,026, filed on Sep. 15, 2017.

(30) Foreign Application Priority Data
May 29, 2018 (JP) 2018-102596

(51) Int. Cl. H02K 7/116; F16H 57/025; H02K 21/14

(52) U.S. Cl. CPC H02K 7/116; F16H 2057/02034; H02K 21/14; F16H 57/025

(57) ABSTRACT

An actuator includes a rotary electric machine including a first rotating shaft rotatable in a circumferential direction about a central axis extending in one direction, and a transmission including a second rotating shaft that is rotatable in the circumferential direction to transfer rotation between the first rotating shaft and the second rotating shaft while changing the speed of the rotation. The rotary electric machine includes a rotor connected to the first rotating shaft, a stator outside of the first rotating shaft, and a casing that houses the rotor and the stator. The transmission includes an internal gear, an external gear to mesh with the internal gear, and a housing that houses the internal gear and the external gear. The actuator further includes a plate extending in an axial direction in which the central axis extends along outer surfaces of the casing and the housing to join the casing and the housing to each other.

### CROSS REFERENCE TO RELATED APPLICATIONS

This application claims the benefit of priority to U.S. Patent Application No. 62/559,026 filed on Sep. 15, 2017 and Japanese Patent Application No. 2018-102596 filed on May 29, 2018. The entire contents of these applications are hereby incorporated herein by reference.

### BACKGROUND OF THE INVENTION

### 1. Field of the Invention

The present invention relates to an actuator.

### 2. Description of the Related Art

JP-A 2009-257409 describes a harmonic speed reducer including, as primary components thereof, a housing, a circular spline, a flexspline, a wave generator, a motor, and a cross-roller bearing. In this harmonic speed reducer, for example, the housing is cylindrical and defines a rotating base of a robot, and the housing includes a plurality of screw hole portions defined at a plurality of positions in a circumferential direction, while a motor base attached to the motor includes a plurality of screw insert hole portions, through which screws are inserted, defined at a plurality of positions. In the harmonic speed reducer described in JP-A 2009-257409, the housing and a wave generator unit, which is defined by the motor, the wave generator, and the motor base, are fixed to each other through the screws at a plurality of positions.

A rotating mechanism, such as a joint of a robot arm, for example, is required to prevent rotation from causing an interference between members. The harmonic speed reducer described in JP-A 2009-257409 is required to have a flange portion in which the screw hole portions or the screw insert hole portions are defined at a plurality of positions in the circumferential direction about a rotation axis. Therefore, when the harmonic speed reducer described in JP-A 2009-257409 is used for a rotating mechanism, a large space to avoid a contact with the flange portion needs to be provided in a member that is arranged to rotate relative to the harmonic speed reducer.

### SUMMARY OF THE INVENTION

An actuator according to a preferred embodiment of the present invention includes a rotary electric machine including a first rotating shaft that is rotatable in a circumferential direction about a central axis extending in one direction; and a transmission including a second rotating shaft that is rotatable in the circumferential direction and transfers rotation between the first rotating shaft and the second rotating shaft while changing a speed of the rotation. The rotary electric machine includes a rotor connected to the first rotating shaft, a stator outside of the first rotating shaft, and a casing that houses the rotor and the stator. The transmission includes an internal gear, an external gear to mesh with the internal gear, and a housing that houses the internal gear and the external gear. The actuator further includes a plate extending in an axial direction in which the central axis extends along outer surfaces of the casing and the housing to join the casing and the housing to each other.

Preferred embodiments of the present invention are able to achieve a reduced size of a space to enable the actuator to operate, and thus achieve a reduced size of the device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an external structure of an actuator according to a preferred embodiment of the present invention.

FIG. 2 is a side sectional view of an actuator according to a preferred embodiment of the present invention.

FIG. 3 is a perspective view illustrating an example exterior of a cam according to a preferred embodiment of the present invention.

FIG. 4 is a perspective view illustrating an example exterior of an external gear according to a preferred embodiment of the present invention.

FIG. 5 is a perspective view illustrating an example exterior of an internal gear according to a preferred embodiment of the present invention.

FIG. 6 is a front view of an actuator according to a preferred embodiment of the present invention.

FIG. 7 is a bottom view of an actuator according to a preferred embodiment of the present invention.

FIG. 8 is a perspective view illustrating a structure of a plate according to a preferred embodiment of the present invention.

FIG. 9 is a bottom view of a housing according to a preferred embodiment of the present invention.

FIG. 10 is a rear view of the actuator according to a preferred embodiment of the present invention, illustrating a section of a portion of the actuator.

FIG. 11 is a bottom view of an actuator according to a modification of a preferred embodiment of the present invention.

### DETAILED DESCRIPTION OF THE PREFERRED EMBODIMENTS

Hereinafter, preferred embodiments of the present invention will be described in detail with reference to the accompanying drawings.

### 1. Overall Structure of Actuator

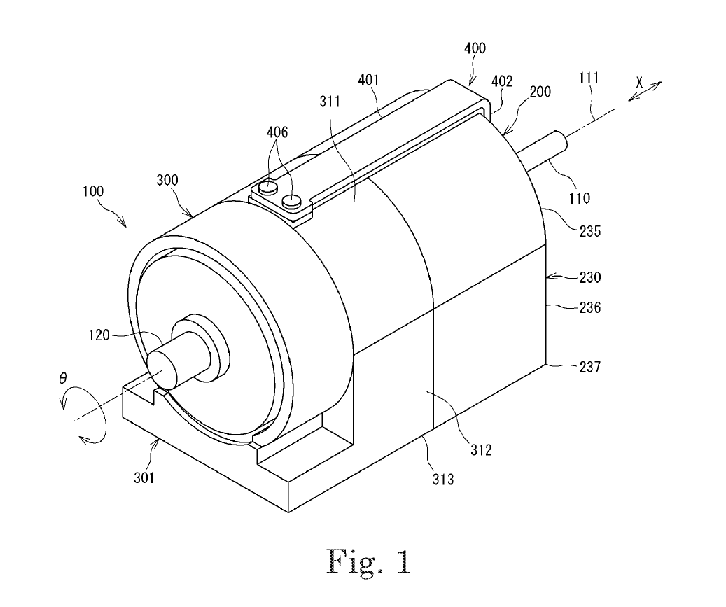

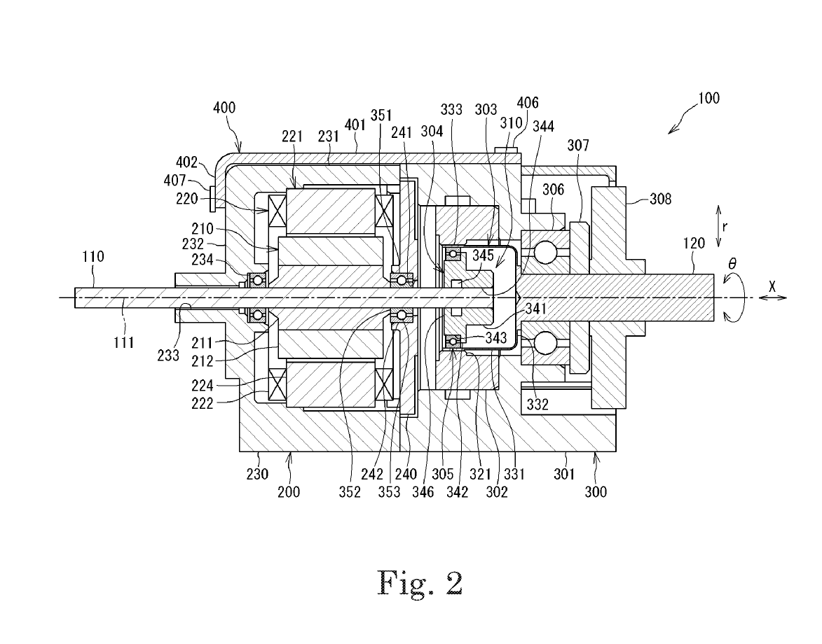

FIG. 1 is a perspective view illustrating the external structure of an actuator 100 according to a preferred embodiment of the present invention. FIG. 2 is a side sectional view of the actuator 100 according to the present preferred embodiment. Referring to FIGS. 1 and 2, the actuator 100 includes a motor (i.e., a rotary electric machine) 200 and a speed reducer (i.e., a transmission) 300. Note that the rotary electric machine may not necessarily be a motor, but may alternatively be an electric generator or a motor generator, which is able to function as both a motor and an electric generator. Also note that the transmission may not necessarily be a speed reducer, but may alternatively be a speed increaser.

### 2. Structure of Motor

The structure of the motor 200 will now be described below with reference to FIG. 2. The motor 200 is arranged to rotate a first rotating shaft 110. The motor 200 includes a rotor 210 fixed to the first rotating shaft 110, and a stator 220 arranged in the shape of a circular ring around the rotor 210. In this preferred embodiment, the rotor 210 is a field component, while the stator 220 is an armature. Note that the rotor 210 and the stator 220 may alternatively be an armature and a field component, respectively. It is assumed in the following description that an axial direction in which a central axis 111 of the first rotating shaft 110 extends is an “x direction”, that a circumferential direction about the central axis 111 is a “θ direction”, and that radial directions centered on the central axis 111 are each an “r direction”.

The rotor 210 includes a cylindrical yoke 211, and a permanent magnet 212 fixed to an outer circumferential surface of the yoke 211. A portion of the first rotating shaft 110 extending in the x direction is housed in the yoke 211, and the yoke 211 is fixed to the first rotating shaft 110. The permanent magnet 212 is arranged on an outer circumference of the yoke 211. The permanent magnet 212 is a ring magnet including south and north poles arranged to alternate with each other in the θ direction, and arranged at regular intervals in the θ direction. Each magnetic pole of the permanent magnet 212 is arranged on a surface facing outward in an r direction, i.e., on a surface facing the stator 220.

The stator 220 includes a core 221 and a plurality of coils 222. The core 221 is made of a soft magnetic material, and includes a plurality of teeth 224. The teeth 224 are arranged at regular intervals in the θ direction. Each tooth 224 is extending in an r direction toward the central axis 111. The number of coils 222 and the number of teeth 224 are equal to each other.

The number of coils 222, that is, the number of slots, is different from the number of poles of the permanent magnet 212. In the case of a three-phase motor, for example, the number of slots is a multiple of three, and the number of poles is an even number.

The motor 200 further includes a casing 230 and a cover 240. The casing 230 includes a tubular portion 231 and a plate-shaped cover portion 232. The tubular portion 231 has a columnar space defined inside thereof, and one end of the tubular portion 231, i.e., an end portion of the tubular portion 231 in the x direction in the example of FIG. 2, is closed by the cover portion 232. The casing 230 is that houses the rotor 210 and the stator 220.

The tubular portion 231 of the casing 230 is arranged to have an inside diameter substantially equal to an outside diameter of the core 221. The core 221 is fixed to an inner circumferential surface of the tubular portion 231 through, for example, an adhesive. The stator 220 is thus fixed to an inner circumferential surface of the casing 230. The cover portion 232 includes a circular hole 233 defined in a center thereof in the r directions. The hole 233 is arranged to have a diameter greater than that of the first rotating shaft 110, and the first rotating shaft 110 is arranged to pass through the hole 233. A bearing 234 in the shape of a circular ring is fitted around the hole 233, and the bearing 234 is arranged to rotatably support the first rotating shaft 110.

The casing 230 is arranged to have an external shape being a combination of a semicircle and a rectangle when viewed in the x direction. In other words, the casing 230 includes a semicircular portion 235 and a flange portion 236, which are semicircular and rectangular, respectively, when viewed in the x direction. A semicircular exterior of the semicircular portion 235 is arranged to be concentric with an inner circumferential surface of the semicircular portion 235. That is, the exterior of the semicircular portion 235 is an arc-shaped surface which is semicircular with the central axis of the first rotating shaft 110 as a center. Meanwhile, the flange portion 236 includes two right-angled corner portions 237 each of which projects in an r direction, and the flange portion 236 is joined to the speed reducer 300 through bolts at the corner portions 237.

The cover 240 is a circular plate having a diameter slightly greater than that of a circular opening of the casing 230. The cover 240 is fixed at the opening of the casing 230 to close the opening. The cover 240 includes a circular hole 241 defined in a center thereof in the r directions. A bearing 242 in the shape of a circular ring is fitted in the hole 241. The bearing 242 is arranged to rotatably support the first rotating shaft 110.

Once electric currents are supplied to the coils 222 of the stator 220, which is the armature, in the motor 200 having the above-described structure, action of electromagnetic induction causes the first rotating shaft 110 to rotate in the θ direction.

### 3. Structure of Speed Reducer

The structure of the speed reducer 300 will now be described below with reference to FIG. 2. The speed reducer 300 is a strain wave gearing device arranged to transfer rotation from the first rotating shaft 110 to a second rotating shaft 120, which is extending in the x direction, while changing the speed of the rotation. The speed reducer 300 includes a housing 301, an internal gear 302, an external gear 303, and a wave generator 310.

The first rotating shaft 110 is extending in the x direction from the cover 240, and the wave generator 310 is connected to one end of the first rotating shaft 110. The wave generator 310 includes a cam 304 and a flexible bearing 305.

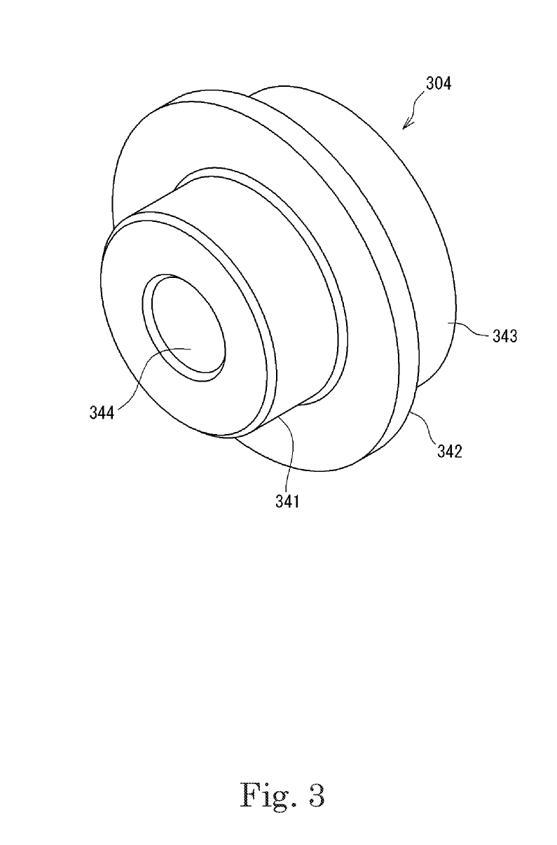

The cam 304 is fixed to one end portion of the first rotating shaft 110. FIG. 3 is a perspective view illustrating an exterior of the cam 304. The cam 304 includes a small diameter portion 341 and a large diameter portion 342 arranged in the x direction. Each of the small diameter portion 341 and the large diameter portion 342 is arranged to have a circular exterior centered on the central axis 111 of the first rotating shaft 110, and the large diameter portion 342 is arranged to have an outside diameter greater than that of the small diameter portion 341. The large diameter portion 342 is arranged closer to the motor 200 than is the small diameter portion 341. An outer circumferential portion of the large diameter portion 342 includes an elliptical decreased diameter portion 343, and the flexible bearing 305 is fitted to the decreased diameter portion 343 (see FIG. 2).

The cam 304 includes a connection hole 344 defined in a center thereof in the r directions. The one end portion of the first rotating shaft 110 is housed in the connection hole 344, and the one end portion of the first rotating shaft 110 is fixed in the connection hole 344 (see FIG. 2). This allows the cam 304 to rotate in the θ direction together with the first rotating shaft 110.

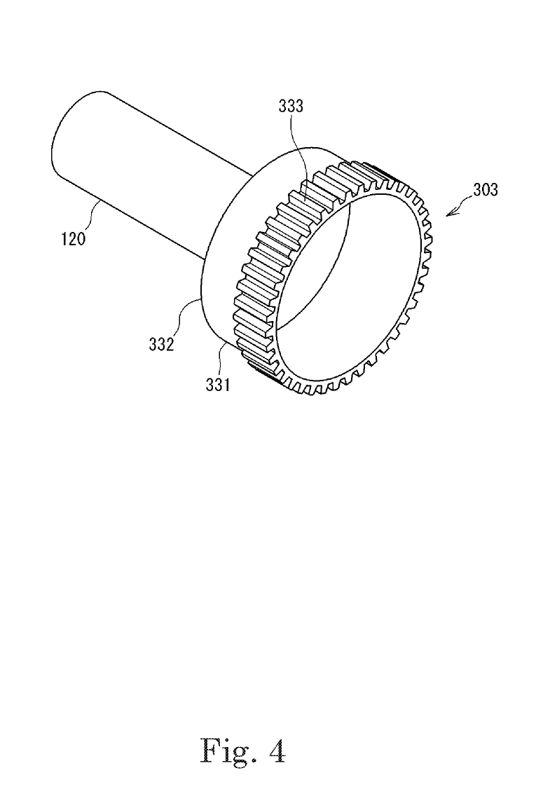

FIG. 4 is a perspective view illustrating an exterior of the external gear 303. The external gear 303 is a cup-shaped external gear which is closed at one end and open at another end in the x direction. That is, the external gear 303 includes a cylindrical portion 331 and a disk-shaped cover portion 332, and the cover portion 332 is arranged to close one end of the cylindrical portion 331. The cylindrical portion 331 is a thin cylinder made of a metal, such as, for example, carbon steel, and is flexible. The cylindrical portion 331 includes an external tooth portion 333 at another end thereof, more specifically, at an outer circumference of an end portion thereof closer to the motor 200.

The cover portion 332 includes surfaces on both sides in the x direction, and the second rotating shaft 120 is extending in the x direction from a center in the r directions of one of the surfaces of the cover portion 332 on an opposite side to the surface thereof on which the cylindrical portion 331 is arranged. The external gear 303 is arranged to be coaxial with the first rotating shaft 110, and the second rotating shaft 120 and the first rotating shaft 110 are arranged coaxially in series (see FIG. 2). The second rotating shaft 120 is fixed to the cover portion 332, and is arranged to rotate in the θ direction together with the cover portion 332.

Reference will now be made to FIG. 2. The cam 304 is housed in the cylindrical portion 331 of the external gear 303. The flexible bearing 305 is arranged between an inner circumferential surface of the cylindrical portion 331 of the external gear 303 and the decreased diameter portion 343 (i.e., an outer circumferential surface) of the cam 304. This allows the external gear 303 and the cam 304 to rotate in the θ direction relative to each other. The flexible bearing 305 includes a flexible outer race member 351, a flexible inner race member 352, and a plurality of balls 353 housed between the outer race member 351 and the inner race member 352, and is capable of being deformed in the r directions.

The cam 304 is a metal block made of, for example, carbon steel, and is arranged to have a high rigidity. Thus, the flexible bearing 305, which is attached to the cam 304, is deformed into an elliptical shape matching an exterior of the decreased diameter portion 343 of the cam 304. In addition, since an inner circumferential surface of the external gear 303 is in contact with the flexible bearing 305, the cylindrical portion 331 of the external gear 303 is deformed into an elliptical shape matching an exterior of the flexible bearing 305.

Similarly to the casing 230 of the motor 200, the housing 301 is arranged to have a shape being a combination of a semicircle and a rectangle when viewed in the x direction (see FIG. 1). In other words, the housing 301 includes a semicircular portion 311 and a flange portion 312, which are semicircular and rectangular, respectively, when viewed in the x direction. The semicircular portion 311 is arranged to have a diameter equal to that of the semicircular portion 235 of the casing 230, and the flange portion 312 includes two right-angled corner portions 313 each of which projects in an r direction. The shape of the flange portion 312 of the housing 301 and the shape of the flange portion 236 of the casing 230 match each other, and the flange portion 312 and the flange portion 236 are fixed to each other through the bolts.

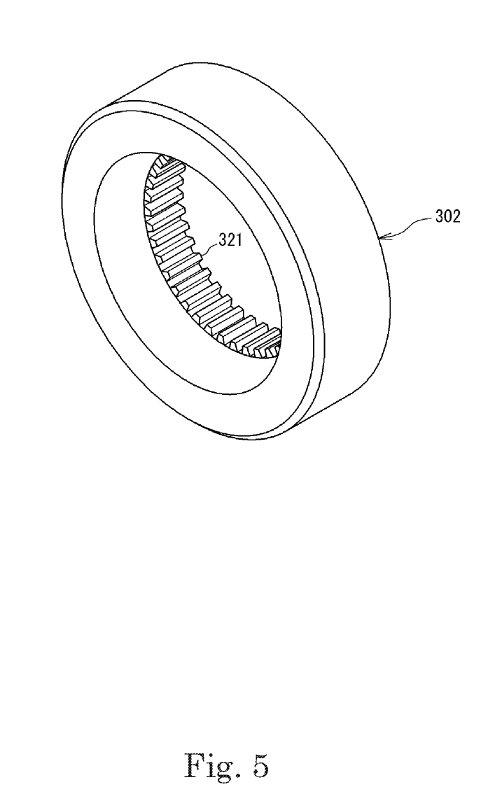

In addition, referring to FIG. 2, the housing 301 has an interior space having a circular section, and the internal gear 302 is housed in this interior space. FIG. 5 is a perspective view illustrating an example exterior of the internal gear 302. The internal gear 302 is in the shape of a circular ring, and is press fitted into the interior space of the housing 301. The housing 301 and the internal gear 302 are fixed to each other. The internal gear 302 includes an internal tooth portion 321 defined in an inner circumference thereof.

Reference will now be made to FIG. 2. The external gear 303 is arranged inside of the internal gear 302. As mentioned above, the external gear 303 is deformed into a shape being elliptical when viewed in the x direction. Accordingly, teeth of the external tooth portion 333 of the external gear 303 which correspond to a major axis mesh with the internal tooth portion 321 of the internal gear 302, while teeth of the external tooth portion 333 which correspond to a minor axis are apart from the internal tooth portion 321.

The number of teeth of the internal tooth portion 321 of the internal gear 302 is different from the number of teeth of the external tooth portion 333 of the external gear 303. For example, when n denotes a positive integer, the number of teeth of the internal tooth portion 321 is arranged to be greater than the number of teeth of the external tooth portion 333 by 2n. Once the first rotating shaft 110 starts rotating, the cam 304 starts rotating together with the first rotating shaft 110. The rotation of the cam 304 causes the external gear 303 to be elastically deformed such that the major axis of the elliptical shape rotates. Accordingly, meshing positions between the external tooth portion 333 and the internal tooth portion 321 move in the θ direction. That is, the wave generator 310 causes the external gear 303 to be deformed in accordance with the rotation of the first rotating shaft 110 such that meshing positions between the internal gear 302 and the external gear 303 shift in the θ direction. Every time the first rotating shaft 110 completes a single rotation, the external gear 303 rotates in the θ direction by an amount corresponding to a difference between the number of teeth of the internal tooth portion 321 and the number of teeth of the external tooth portion 333. As a result, the rotation of the first rotating shaft 110 is transferred to the second rotating shaft 120 while the speed of the rotation is reduced.

A bearing 306 is attached to the housing 301, and the bearing 306 is arranged to support the second rotating shaft 120 such that the second rotating shaft 120 is capable of rotating about the central axis 111. In addition, a washer 307 and a disk-shaped plate member 308 are attached to the second rotating shaft 120 such that the bearing 306, the washer 307, and the plate member 308 are arranged in the x direction.

### 4. How Housing and Casing are Joined to Each Other

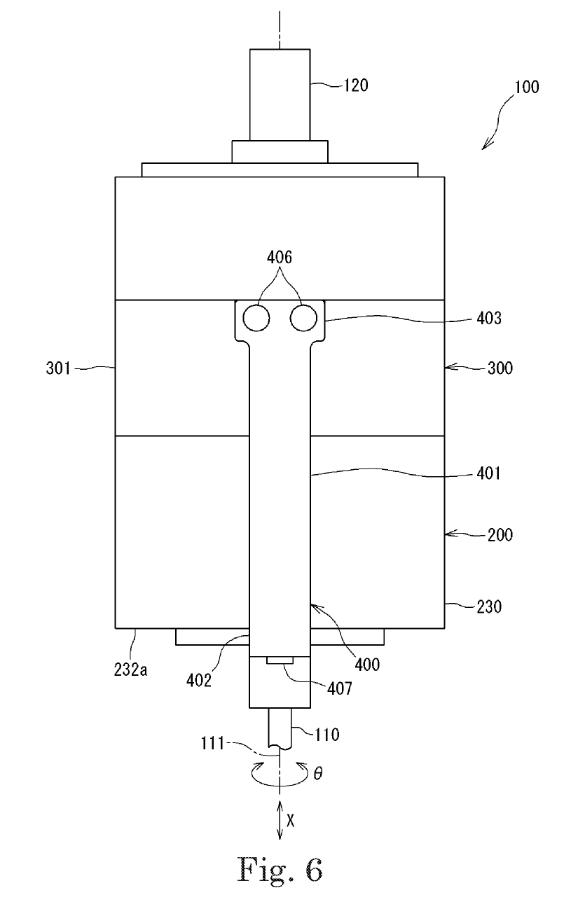

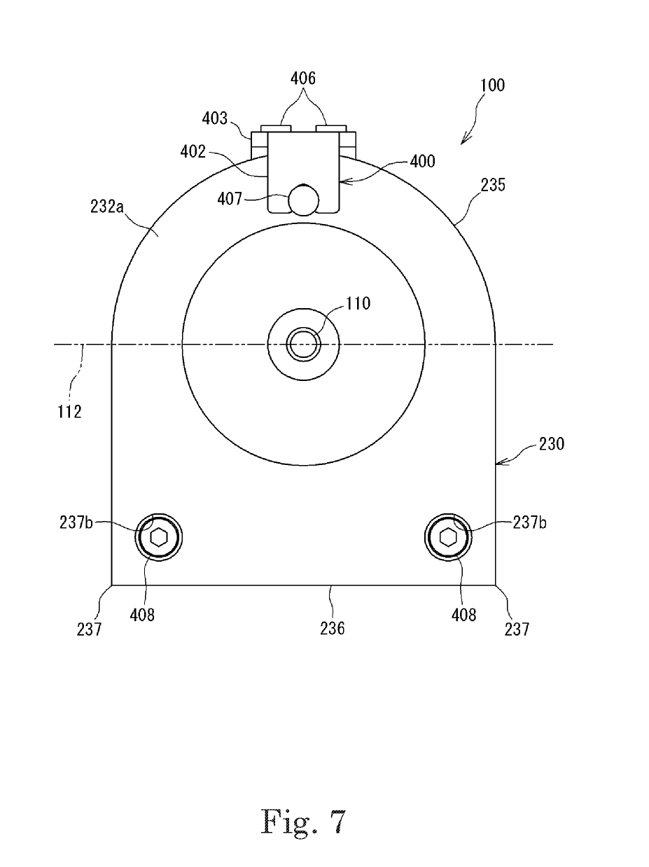

FIG. 6 is a front view of the actuator 100 according to the present preferred embodiment, and FIG. 7 is a bottom view of the actuator 100. The casing 230 of the motor 200 and the housing 301 of the speed reducer 300 are joined to each other through a plate 400.

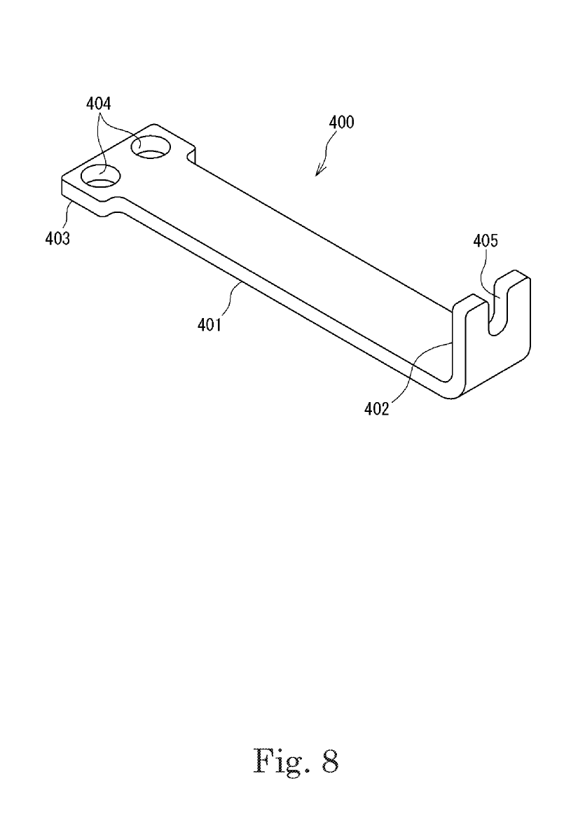

FIG. 8 is a perspective view illustrating the structure of the plate 400. The plate 400 includes a plate body portion 401 and a plate flange portion 402. The plate body portion 401 is a plate-shaped portion extending in the x direction. The plate body portion 401 includes an increased width portion 403 having an increased width at one end in the x direction, and is joined to the plate flange portion 402 at another end in the x direction. The increased width portion 403 includes two fitting holes 404 defined therein.

The plate flange portion 402 is extending in a thickness direction of the plate body portion 401, i.e., in an r direction, from the other end of the plate body portion 401 in the x direction. The plate flange portion 402 is a plate-shaped portion having the same width and thickness as those of the plate body portion 401, and is arranged to have a length smaller than that of the plate body portion 401. In addition, the plate flange portion 402 includes a cut portion 405 at an end thereof.

Reference will now be made to FIGS. 6 and 7. The plate body portion 401 is joined to the housing 301 in the r direction through two screws 406. Each of the screws 406 is passed through a separate one of the fitting holes 404, and is screwed into a screw hole (not shown) defined in the housing 301. Thus, an interference between the plate 400 and an object connected to the second rotating shaft 120 can be avoided, without the need for the plate body portion 401 to protrude in the x direction from the housing 301.

Meanwhile, the plate flange portion 402 is joined in the x direction to an end surface 232a of the casing 230 on one side in the x direction through a screw 407. The end surface 232a is an end surface on a side away from the speed reducer 300, that is, an end surface of the cover portion 232. Thus, the casing 230 and the housing 301 can be firmly joined to each other.

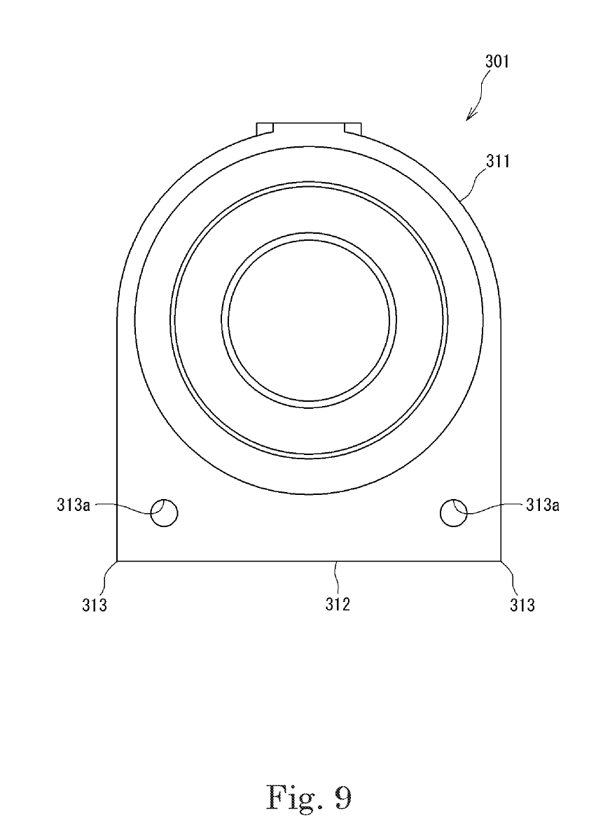

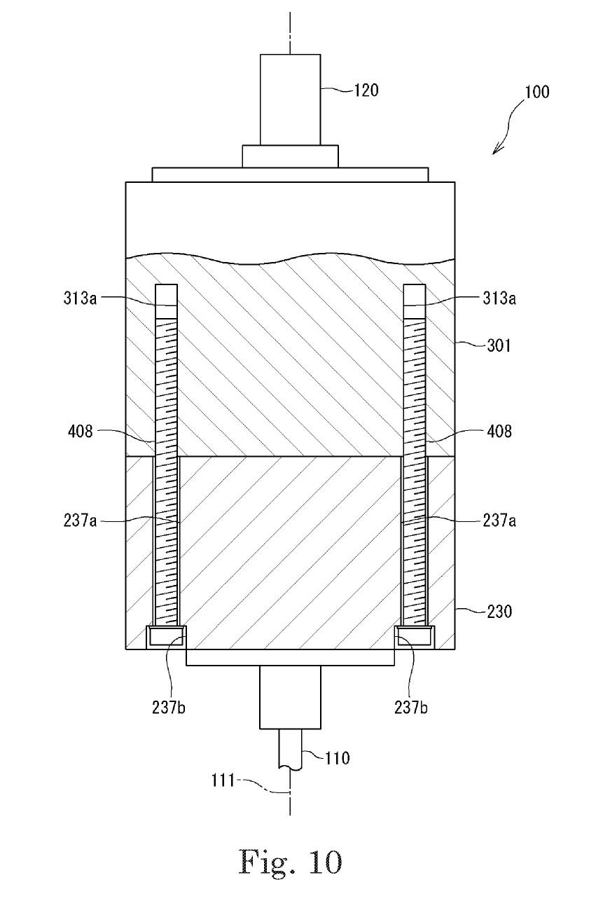

FIG. 9 is a bottom view of the housing 301 according to a preferred embodiment of the present invention, and FIG. 10 is a rear view of the actuator 100 according to a preferred embodiment of the present invention, illustrating a section of a portion of the actuator 100. Referring to FIGS. 7, 9 and 10, the flange portion 236 (hereinafter referred to as a first flange portion 236) of the casing 230 and the flange portion 312 (hereinafter referred to as a second flange portion 312) of the housing 301 are joined to each other in the x direction through two bolts (screws) 408. Each of the two corner portions 237 of the first flange portion 236 includes a first hole 237a. In addition, each of the two corner portions 313 of the second flange portion 312 includes a second hole 313a. Each first hole 237a is a columnar hole having a diameter greater than that of a shank portion of each bolt 408 and smaller than that of a head portion of the bolt 408, and is extending in the x direction. Each second hole 313a is a female screw which can be joined to a male screw of the bolt 408, and is extending in the x direction.

In addition, the end surface 232a of the casing 230 includes counterbore holes 237b each of which is arranged to have a diameter greater than that of the head portion of the bolt 408. Each first hole 237a is extending coaxially from a separate one of the counterbore holes 237b. The head portion of each bolt 408 is housed in the corresponding counterbore hole 237b.

Each first hole 237a is extending over an entire extent of the casing 230 in the x direction. That is, each first hole 237a is arranged to pass through the casing 230. The dimension of each second hole 313a measured in the x direction is smaller than the dimension of the housing 301 measured in the x direction. That is, each second hole 313a is extending from an end surface of the housing 301 on the one side in the x direction, that is, a surface of the housing 301 which is opposed to the casing 230, up to an intermediate point in the housing 301 in the x direction.

The dimension of the shank portion of each bolt 408 measured in the x direction is greater than the dimension of each first hole 237a measured in the x direction. Accordingly, the bolt 408 passes through the corresponding first hole 237a in the x direction. In addition, the dimension of the shank portion of the bolt 408 measured in the x direction is smaller than a sum of the dimensions of the first hole 237a and the second hole 313a measured in the x direction. Thus, the bolt 408 is screwed into the corresponding second hole 313a up to an intermediate point along the second hole 313a.

As described above, the casing 230 and the housing 301 are joined to each other through the plate 400 and the two bolts 408. Thus, the casing 230 and the housing 301 can be firmly joined to each other.

Referring to FIG. 7, positions at which the casing 230 and the housing 301 are secured to each other by the bolts 408 are two positions apart from each other in the θ direction. That is, the two first holes 237a are arranged at two positions apart from each other in the θ direction, and the two second holes 313a are also arranged at two positions apart from each other in the θ direction.

It is assumed here that there is a straight line 112 being perpendicular to the central axis 111 when viewed in the x direction. In the casing 230, the first flange portion 236 is arranged in one of two regions divided by the straight line 112, while the semicircular portion 235 (hereinafter referred to as a first semicircular portion 235) is arranged in another one of the two regions. In the housing 301, the second flange portion 312 is arranged in the one of the two regions divided by the straight line 112, while the semicircular portion 311 (hereinafter referred to as a second semicircular portion 311) is arranged in the other one of the two regions. That is, the two first holes 237a are arranged in the one of the two regions divided by the straight line 112. Similarly, the two second holes 313a are arranged in the one of the two regions divided by the straight line 112. As described above, the first holes 237a and the second holes 313a, i.e., two pairs of holes, are arranged in the one of the two regions, and this eliminates the need to provide flange portions in the other one of the two regions, reducing the size of a portion of each of the casing 230 and the housing 301 in the other one of the two regions.

In addition, referring to FIG. 7, the single plate 400 is attached to portions of the first semicircular portion 235 and the second semicircular portion 311 which are opposite to the first flange portion 236 and the second flange portion 312. That is, the plate 400 is arranged in the other one of the two regions divided by the straight line 112. As described above, the casing 230 and the housing 301 are joined to each other by the plate 400 in the other one of the two regions, which is different from the region including the positions at which the casing 230 and the housing 301 are secured to each other by the bolts 408, and thus, the positions at which the casing 230 and the housing 301 are secured to each other are evenly spaced from one another in the θ direction to firmly join the casing 230 and the housing 301 to each other.

In addition, the single plate 400 is arranged at a position equally spaced apart from each of the two first holes 237a in the θ direction. Similarly, the single plate 400 is also equally spaced apart from each of the two second holes 313a in the θ direction. Thus, the casing 230 and the housing 301 can be joined to each other by the single plate 400 at the position equally spaced apart in the θ direction from each of the two positions at which the casing 230 and the housing 301 are joined to each other by the bolts 408, and this contributes to effectively preventing a misalignment between the casing 230 and the housing 301.

### 5. Example Modifications

Speed reducers according to example modifications of the present preferred embodiment will now be described below.

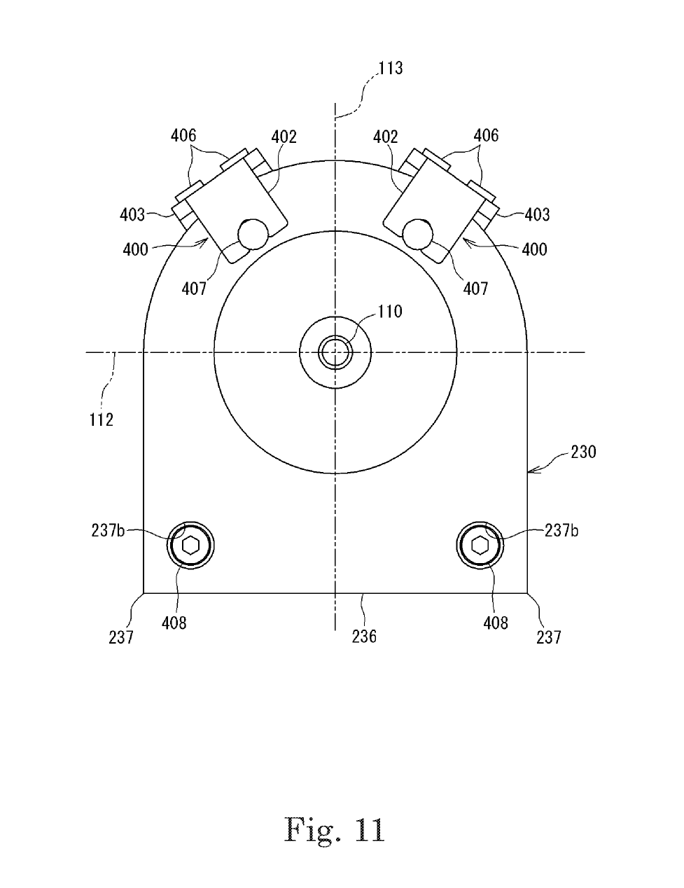

FIG. 11 is a bottom view of an actuator according to a modification of the above-described preferred embodiment. In this modification, two plates 400 are provided to join a casing 230 and a housing 301 to each other. The two plates 400 are arranged side by side in the θ direction on a first semicircular portion 235 and a second semicircular portion 311. Thus, the casing 230 and the housing 301 can be joined to each other in a firmer and more compact manner.

Referring to FIG. 11, the two plates 400 are arranged in one of two regions divided by a straight line 112 which is different from a region including positions at which the casing 230 and the housing 301 are secured to each other by bolts 408. In addition, the two plates 400 are arranged symmetrically with respect to a straight line 113 perpendicular to the straight line 112 when viewed in the x direction. The positions at which the casing 230 and the housing 301 are secured to each other by the two bolts 408 are also arranged symmetrically with respect to the straight line 113. That is, the positions at which the casing 230 and the housing 301 are joined to each other are arranged symmetrically with respect to the straight line 113. This arrangement of the joining positions allows the casing 230 and the housing 301 to be joined to each other with the same condition in each of two regions divided by the straight line 113, so that the casing 230 and the housing 301 can be joined to each other in a well-balanced manner.

### 5-1. Other Example Modifications

Note that the number of plates 400 is not limited to one or two. Three or more plates 400 may alternatively be arranged side by side in the θ direction on the first semicircular portion 235 and the second semicircular portion 311.

In the actuator 100 according to the above-described preferred embodiment, the casing 230 includes the first holes 237a, the housing 301 includes the second holes 313a, each of which is a screw hole, and the shank portion of each bolt 408 is passed through the corresponding first hole 237a, and is screwed into the corresponding second hole 313a. Note, however, that this is not essential to the present invention. In an actuator according to another preferred embodiment of the present invention, a first flange portion 236 of a casing 230 and a second flange portion 312 of a housing 301 may be joined to each other through a bolt and a nut. Specifically, each of a first hole 237a and a second hole 313a may be a columnar hole having a diameter greater than that of a shank portion of a bolt 408, the shank portion of the bolt 408 may be passed through the first hole 237a and the second hole 313a, and a nut may be screwed onto the shank portion.

In addition, in the actuator 100 according to the above-described preferred embodiment of the present invention, the first rotating shaft 110 is connected to the motor 200, which is an example of a rotary electric machine. Note, however, that actuators according to other preferred embodiments of the present invention may have another structure. In another preferred embodiment of the present invention, an electric generator, which is another example of a rotary electric machine, may be connected to a first rotating shaft 110. In yet another preferred embodiment of the present invention, a second rotating shaft 120 may be connected to a rotary electric machine, such as, for example, a motor, an electric generator, or a motor generator.

Note that the speed reducer 300 may not necessarily be the strain wave gearing device, but may alternatively be any other desirable transmission arranged to transfer rotation between the first rotating shaft 110 and the second rotating shaft while changing the speed of the rotation. Also note that the speed reducer 300 may alternatively be a planetary transmission.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An actuator comprising:
a rotary electric machine including a first rotating shaft that is rotatable in a circumferential direction about a central axis extending in one direction; and
a transmission including a second rotating shaft that is rotatable in the circumferential direction, and that transfers rotation between the first rotating shaft and the second rotating shaft while changing a speed of the rotation; wherein
the rotary electric machine includes:
a rotor connected to the first rotating shaft;
a stator located outside of the first rotating shaft; and
a casing that houses the rotor and the stator;
the transmission includes:
an internal gear;
an external gear to mesh with the internal gear; and
a housing that houses the internal gear and the external gear; and
the actuator further comprises a plate extending in an axial direction in which the central axis extends along outer surfaces of the casing and the housing to join the casing and the housing to each other.

2. The actuator according to claim 1, wherein
the casing includes a first flange portion projecting in radial directions centered on the central axis;
the housing includes a second flange portion projecting in the radial directions, and opposite to the first flange portion in the axial direction; and
the first and second flange portions are joined to each other through a screw extending in the axial direction.

3. The actuator according to claim 2, wherein
the first flange portion includes two first holes spaced apart from each other in the circumferential direction and extending in the axial direction;
the first holes are located in one of two regions divided by a straight line perpendicular or substantially perpendicular to the central axis when viewed in the axial direction;
the second flange portion includes two second holes each of which is coaxial with a separate one of the first holes when viewed in the axial direction and extending in the axial direction; and
two of the screws are inserted into the first and second holes.

4. The actuator according to claim 3, wherein the plate is located at a position equally spaced apart from each of the two first holes in the circumferential direction.

5. The actuator according to claim 3, wherein a plurality of the plates are arranged side by side in the circumferential direction.

6. The actuator according to claim 1, wherein
the plate includes a plate body portion extending in the axial direction, and a plate flange portion extending in a radial direction centered on the central axis from one end of the plate body portion in the axial direction;
the plate body portion is joined to the housing in the radial direction; and
the plate flange portion is joined in the axial direction to an end surface of the casing on one side in the axial direction.

7. The actuator according to claim 6, wherein the plate flange portion is joined to the end surface of the casing via a screw.

8. The actuator according to claim 6, wherein the plate body portion is joined to the outer surface of the housing via a plurality of screws.
